(19) United States
(12) Patent Application Publication
(10) Pub. No.: US 2023/0398952 A1
(43) Pub. Date: Dec. 14, 2023

(54) Emblem Retainer

(71) Applicant: Illinois Tool Works Inc., Glenview, IL (US)

(72) Inventor: Mark A. Beyer, Armada, MI (US)

(21) Appl. No.: 18/202,740

(22) Filed: May 26, 2023

Related U.S. Application Data
(60) Provisional application No. 63/350,612, filed on Jun. 9, 2022.

(51) Int. Cl. B60R 13/00

(52) U.S. Cl. CPC B60R 13/005

(57) ABSTRACT

Disclosed are systems and methods for retaining system coupling a component to a panel via a retainer. The retainer can couple a component with panels of different thicknesses. The retainer comprising a body portion and at least one panel-engagement feature coupled to the body portion. The body portion having a pair of legs spaced apart and flexibly connected to one another to define a channel. The channel is sized and shaped to receive a tower associated with the component. The at least one panel-engagement feature is coupled to one of the pair of legs to engages an opening of a panel having a thickness ranging from a first thickness (T₁) to a second thickness (T₂) that is greater than the first thickness (T₁).

### CROSS-REFERENCE

The present application claims the benefit under 35 U.S.C. § 119(e) of U.S. Provisional Patent Application Ser. No. 63/350,612, filed Jun. 9, 2022 and titled “Emblem Retainer,” the contents of which are hereby incorporated by reference.

### BACKGROUND

A metal retainer can be used to make a blind connection between a component and a panel, such as automotive components and panels. Traditionally, a simple metal retainer can be received within an opening (e.g., a window or aperture) formed in a primary panel and configured to engage a blade structure that extends from an undersurface of a component, which could be a secondary panel. Existing retainers have a limited allowable panel thickness range, meaning that a retainer is traditionally designed to secure to panels of a given thickness and with a smaller tolerance. Further, existing retainers are typically secured to the blade using only small barbs.

In view of the foregoing, a need exists for a retaining system with a retainer that can be used to across a larger range of panel thickness, thereby reducing the amount of different retainers currently needed due to limited panel range applicability while also allowing for a robust attachment.

### SUMMARY

The present disclosure relates generally to a retaining system to form a blind connection between a component and a panel, such as automotive components and panels, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a perspective assembly view of an example retaining system in accordance with aspects of this disclosure.

FIG. 1b illustrates a perspective assembled view of the example retaining system with a thin panel.

FIG. 1c illustrates a perspective assembled view of the example retaining system with a thick panel.

FIG. 1d illustrates a side assembled view of the example retaining system with the thin panel.

FIG. 1e illustrates a side assembled view of the example retaining system with the thick panel.

FIG. 2a illustrates a perspective view of a retainer in accordance with an aspect of this disclosure.

FIG. 2b illustrates a top plan view of the retainer of FIG. 2a.

FIG. 2c illustrates a bottom plan view of the retainer of FIG. 2a.

FIGS. 2d through 2g illustrate first, second, third, and fourth side elevation views of the retainer of FIG. 2a.

FIG. 3a illustrates a perspective view of a retainer in accordance with another aspect of this disclosure.

FIG. 3b illustrates a top plan view of the retainer of FIG. 3a.

FIG. 3c illustrates a bottom plan view of the retainer of FIG. 3a.

FIGS. 3d through 3g illustrate first, second, third, and fourth side elevation views of the retainer of FIG. 3a.

FIG. 4a illustrates a perspective view of a retainer in accordance with another aspect of this disclosure.

FIG. 4b illustrates a top plan view of the retainer of FIG. 4a.

FIG. 4c illustrates a bottom plan view of the retainer of FIG. 4a.

FIGS. 4d through 4g illustrate first, second, third, and fourth side elevation views of the retainer of FIG. 4a.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Existing fasteners have a limited allowable panel thickness range, meaning that a fastener is traditionally designed to secure to panels of a given thickness and with a smaller tolerance. Further, existing fasteners are typically secured to the blade using small barbs. To that end, the subject disclosure is directed to fasteners that can be used to across a larger range of panel thicknesses, thereby reducing the number of different fastener versions needed to handle panel ranges. The disclosed fasteners also allow for a robust attachment to the tower. That is, whereas fasteners are typically secured to the tower by only a series of small barb features, the disclosed fastener provides retention at multiple points along the length of the tower to yield higher retention values relative to the tower.

In one example, a retainer to couple a component with panels of different thicknesses comprises: a retaining head portion; a body portion extending from the retaining head portion, the body portion having a pair of legs spaced apart and flexibly connected to one another to define a channel, wherein the channel is configured to receive a tower associated with the component; and at least one panel-engagement feature coupled to one of the pair of legs and configured to engage an opening of a panel having a thickness ranging from a first thickness (T₁) to a second thickness (T₂) that is greater than the first thickness (T₁).

In another example, a stamped-metal retainer to couple a component with panels of different thicknesses comprises: a body portion having a pair of legs spaced apart and flexibly connected to one another to define a channel, wherein the channel is configured to receive a tower associated with the component; and at least one panel-engagement feature coupled to one of the pair of legs and configured to engage an opening of a panel having a thickness ranging from a first thickness (T₁) to a second thickness (T₂) that is greater than the first thickness (T₁), wherein the at least one panel-engagement feature is a saw-tooth structure.

In another example, a stamped-metal retainer to couple a component with panels of different thicknesses comprises: a body portion having a pair of legs spaced apart and flexibly connected to one another to define a channel, wherein the channel is configured to receive a tower associated with the component; and at least one panel-engagement feature coupled to one of the pair of legs and configured to engage an opening of a panel having a thickness ranging from a first thickness (T₁) to a second thickness (T₂) that is greater than the first thickness (T₁), wherein the at least one panel-engagement feature is arranged to both engage and retain the tower within the channel and engage and retain the retainer within the opening.

In some examples, the at least one panel-engagement feature is a saw-tooth structure. The saw-tooth structure can comprise a fin and a plurality of steps. Each of the plurality of steps can be offset relative to the one of the pair of legs.

In some examples, the at least one panel-engagement feature includes a plurality of spring-tab structures. Each of the plurality of spring-tab structures can comprise a spring tab resiliently connected at a first end to one of the pair of legs and a foot coupled to a second end of the spring tab. The foot can be oriented toward the channel. In some examples, each of the plurality of spring-tab structures are of a different length.

In some examples, the retainer further comprises a retaining tab extending inwardly from one of the pair of legs to the channel. In some examples, the retainer further comprises a pair of flanges, wherein each of the pair of flanges is connected to and extends outwardly from the body portion. In some examples, each of the pair of flanges is shaped as a spring to absorb movement between the component and the panel. In some examples, the at least one panel-engagement feature is arranged to both engage and retain the tower within the channel and engage and retain the retainer within the opening. In some examples, the pair of legs are parallel to one another.

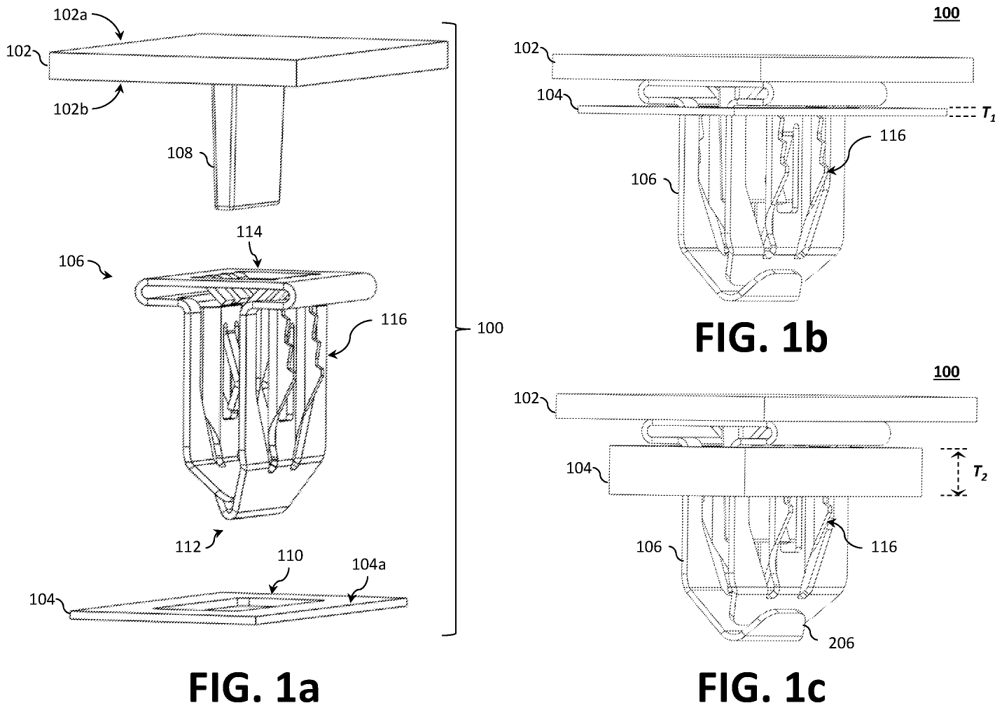

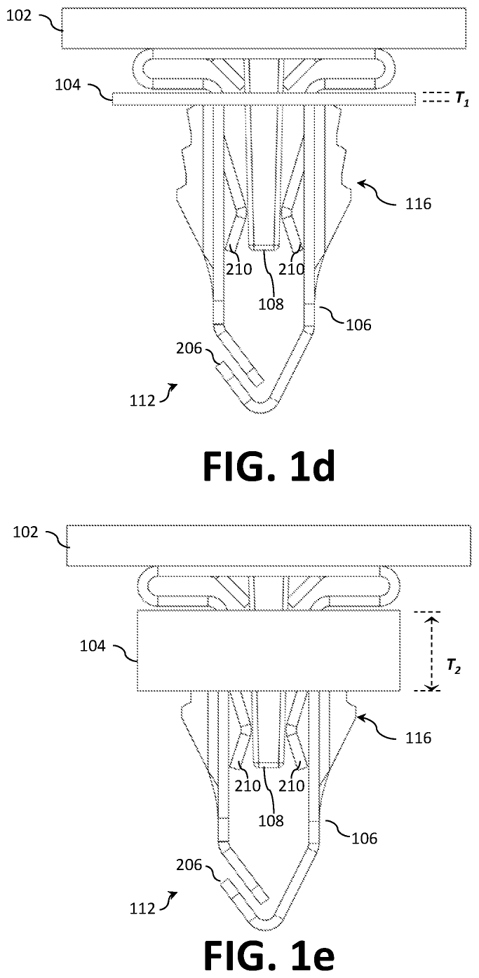

FIG. 1a illustrates a perspective assembly view of an example retaining system 100 in accordance with aspects of this disclosure. FIGS. 1b and 1c illustrate, respectively, perspective assembled views of the example retaining system 100 with a thin panel 104 having a first thickness (T₁) and a thick panel 104 having a second thickness (T₂). FIGS. 1d and 1e illustrate, respectively, side assembled views of the example retaining system 100 with the thin panel 104 and the thick panel 104. As illustrated, the retaining system 100 generally comprises a component 102 that is coupled to a panel 104 via a retainer 106 (aka, a clip or fastener) to form a blind connection between the component 102 and the panel 104. As will become apparent, it can be useful to assemble a panel 104 and a component 102 by first inserting the retainer 106 into the opening 110 of the panel 104 and then subsequently inserting a tower 108 of the component 102 into the retainer 106 to form the assembly.

The retainers 106 disclosed herein can be used to form the blind connection with panels of various, different thicknesses. The retainers 106 can be fabricated from, for example, sheet metal via a metal stamping process. For example, a flat blank can be stamped from a sheet of metal and then bent to form the finished stamped-metal retainer 106. Depending on the application, the component 102 and the panel 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In one example, the component 102 is an automotive secondary panel and the panel 104 is an automotive primary panel. In the automotive industry, example components 102 include, without limitation, emblems, door trim panels, moldings, trim pieces, and other substrates (whether use on the interior and exterior surfaces).

The component 102 may define an A-surface 102a and a B-surface 102b (illustrated as an undersurface). The A-surface 102a, also called a class A surface, is typically the surface that is visible after assembly and, for that reason, is more aesthetically pleasing (e.g., include a logo, textured, coated, or otherwise decorated) and typically free of attachment devices and/or related features. Conversely, the B-surface 102b, also called a class B surface, is typically the surface that is not visible after assembly and typically includes various attachment devices and/or related features, such as the towers 108.

The component 102 may include, define, or otherwise be associated with attachment devices and/or related features, such as one or more towers 108. For example, the illustrated component 102 includes at least one tower 108 that protrudes from the B-surface 102b. Each tower 108 (sometimes called a blade or protrusion) may be shaped as a blade or planar tab, for example. Depending on the material type, the one or more towers 108 may be formed on the B-surface 102b during molding or layup of the component 102, or attached after fabrication (e.g., using adhesive or mechanical fasteners).

To form the blind connection between the component 102 and the panel 104, a leading end 112 of the retainer 106 is first inserted into an opening 110 formed in or on a surface 104a of the panel 104. In some examples, the retainer 106 can be inserted into the opening 110 to define a part-in-assembly (PIA). Further, the opening 110 can be sized and shaped to also reinforce the retainer 106 in resisting removal. Once the retainer 106 is inserted into opening 110, the tower 108 of the component 102 can be inserted into a channel formed by the retainer 106 via a window 114 to, in effect, lock the retainer 106 in place, thus securing the component 102 and the panel 104 to one another.

After assembly, the panel 104 is covered at least partially by the component 102. The panel 104 may be, for example, a structural component of a vehicle, such as doors, pillars (e.g., an A-pillar, B-Pillar, C-Pillar, etc.), dashboard components (e.g., a cross member, bracket, frame, etc.), seat frames, center consoles, fenders, sheet metal framework, or the like.

As illustrated, the retainer 106 comprises one or more panel-engagement features 116 to allow the retainer 106 to engage in a wider range of panels 104 (e.g., panels of various thicknesses), while also providing for a more secure engagement with the tower 108. For example, as best illustrated in FIGS. 1b and 1c, the panel-engagement features 116 enable the retainer 106 to couple with a thin panel 104 having a first thickness (T₁) (e.g., a minimum thickness), a thick panel 104 (e.g., a maximum thickness) having a second thickness (T₂), and various third thicknesses (e.g., intermediate thicknesses) in between the first thickness (T₁) and the second thickness (T₂). As will be discussed in connection with the following figures, the panel-engagement features 116 can be provided as, for example, saw-tooth structures and/or spring-tab structures.

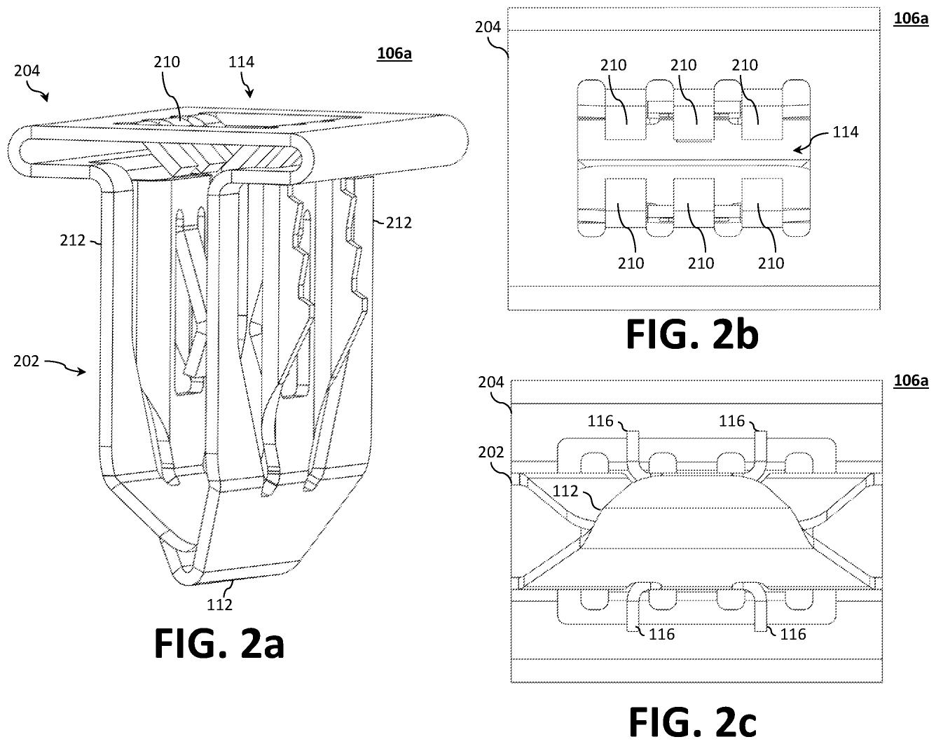

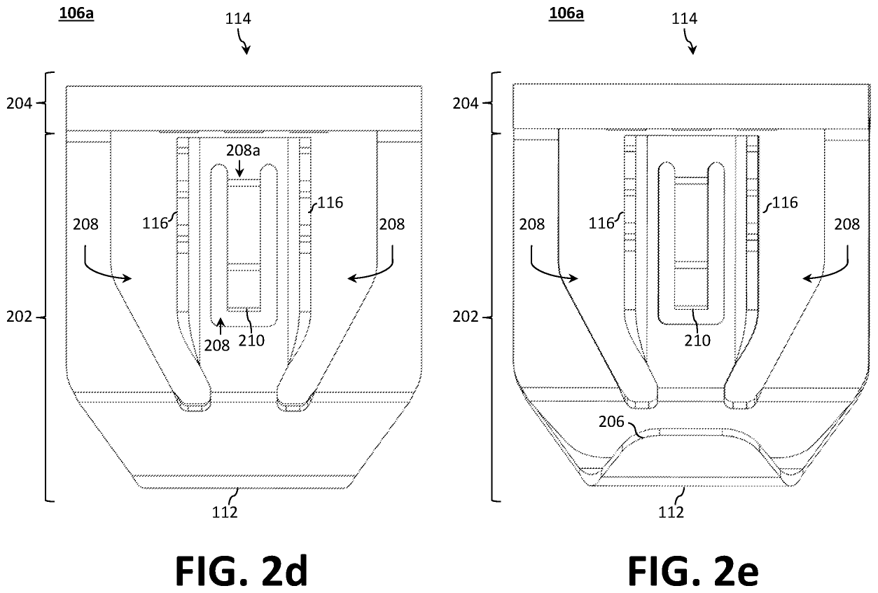

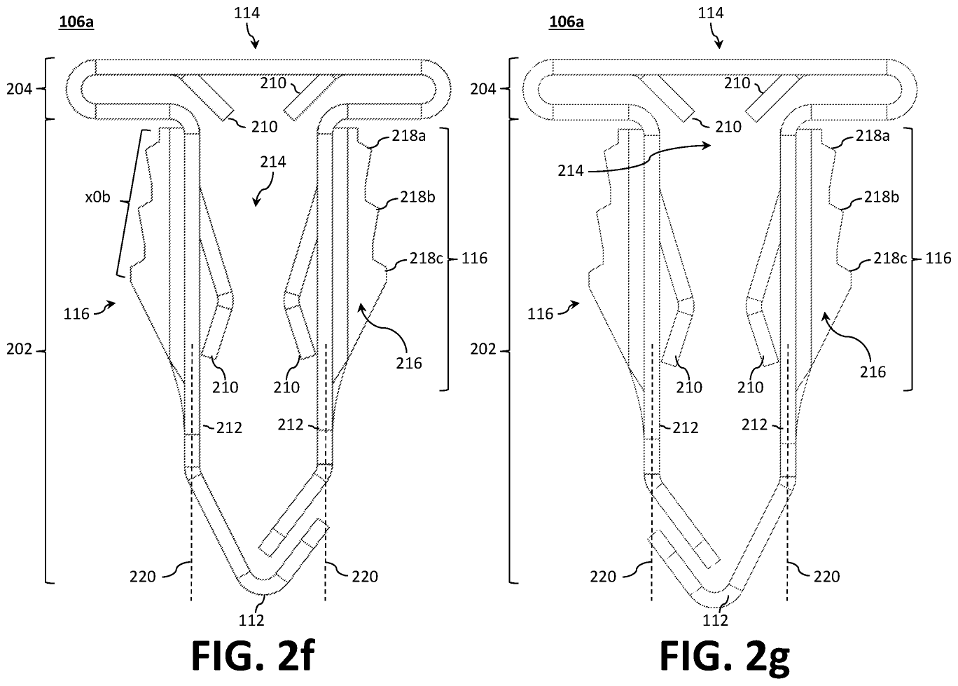

FIG. 2a illustrates a perspective view of a retainer 106a in accordance with an aspect of this disclosure. FIG. 2b illustrates a top plan view of the retainer 106a, while FIG. 2c illustrates a bottom plan view of the retainer 106a of FIG. 2a. FIGS. 2d through 2g illustrate first, second, third, and fourth side elevation views of the retainer 106a. As noted previously, the disclosed retainers, including retainer 106a, can be stamped-metal retainers. For example, a flat sheet of metal may be stamped (e.g., die stamped) to define the outer perimeter, profile, and various apertures 208 to define its various features of the retainer 106a, including, inter alia, the panel-engagement features 116, retaining tabs 210, etc. After stamping, the flat sheet metal blank can be bent and/or upturned along one or more lines or at one of more points through one or more manufacturing steps to define the retainer 106a and the various features thereof. The retainer 106a may be fabricated in various sizes depending on the application.

As illustrated, the retainer 106a generally comprises a body portion 202 and a retaining head portion 204. The body portion 202 is formed from a pair of opposing legs 212 that are resiliently connected at their upper ends via the retaining head portion 204 to form a channel 214 therebetween, which is accessible to the tower 108 via the window 114 formed in or through the head portion 204.

The pair of opposing legs 212 are resiliently connected such that the pair of opposing legs 212 default (e.g., spring back) to a predetermined shape. For example, as best illustrated in FIGS. 2f and 2g, the channel 214 has a cross section that is generally U-shaped. During assembly, the legs 212 may be biased (e.g., pushed) inward and/or outward, but, in the absence of such external forces, return to the default, generally U-shaped shape. As illustrated, the pair of legs 212 are generally parallel to one another. For example, the pair of legs 212 defines a pair of leg planes 220 that are generally parallel to one another. Alternatively, the legs 212 may be angled or biased outwardly at the such that the leg planes 220 of the pair of legs 212 form an angle with one another that is non-parallel.

In the illustrated example, the legs 212 at the leading end 112 of the retainer 106a are not fixedly coupled to one another, thereby allowing the pair of opposing legs 212 to flex relative to one another since, in this example, they are resiliently connected to one another via the head portion 204 (though other configurations are contemplated). As illustrated, a flap of material 206 is wrapped around the leading end 112 of the retainer 106a to prevent it from catching or snagging during installation, as well as preventing nesting during shipment and handling.

As illustrated, each of the legs 212 is formed with one or more apertures 208 therethrough, which serve to form and/or define the various features of the retainer 106a and, in some cases, to reduce weight and material. The retaining head portion 204 can likewise include apertures 208. The size and shape of the aperture 208 can vary, which is often dictated by the feature being punched from the sheet metal. For example, the panel-engagement features 116, retaining tabs 210, etc. can be stamped and bent outward (away from the channel 214) or inward (toward the channel 214) using the material punched from the aperture 208.

In the illustrated example, the retainer 106a includes four panel-engagement features 116, although additional or fewer panel-engagement features 116 may be provided based on, for example, the size and/or dimensions of the body portion 202. In this example, the panel-engagement features 116 is a saw-tooth structure having a fin 216 with a plurality of steps 218 (e.g., teeth, ledges, etc.). In some examples, as illustrated, a leading edge of the fin 216 is angled relative to the leg plane 220 of the respective leg 212 to form a ramp to better guide the panel-engagement feature 116 and the body portion 202 into the opening 110 during installation. Further, the plurality of steps 218 can be staggered/offset relative to the leg plane 220 at different distances to increase engagement with the panel as the leg 212 flexes inwardly during installation. Once installed, one or more of the steps 218 engage and/or dig into the material of the panel 104 to resist pullout. The number of the steps 218 that engage and/or dig into the material of the panel 104 can be dictated by the thickness of the panel 104.

In the illustrated example, each panel-engagement feature 116 includes a fin 216 and three steps 218a, 218b, 218c; however, additional or fewer steps 218 can be employed depending on the length of the body portion 202 and/or the desired range of acceptable panel thicknesses for the panel 104. For example, a greater number of steps 218 allows for compatibility with thicker panels 104. In the illustrated examples, a thin panel 104 having a first thickness (T₁) would be secured between the head portion 204 and the step 218a farthest from the leading end 112 (i.e., the step 218a adjacent the head portion 204) as illustrated in FIG. 1d, whereas a thick panel 104 (e.g., a maximum thickness) having a second thickness (T₂) would be secured between the head portion 204 and the step 218c nearest the leading end 112 as illustrated in FIG. 1e. In the latter example, the other steps 218 could engage and/or dig into the material of the panel 104 at the opening 110 to resist pullout.

The panel-engagement features 116 can be connected to its respective leg 212 along its length such that it doesn't flex relative to the leg 212, but instead moves as the leg 212 flexes. The panel-engagement features 116 on opposite sides of the channel 214 may be symmetrical with respect to one another. In other examples, the one or more panel-engagement features 116 may be provided on only one side of the channel 214. The panel-engagement features 116 may be formed, for example, during a stamping process and bent outward away from the channel 214. Therefore, the panel-engagement feature 116 may be integral with its respective leg 212. In the illustrated example, the fin 216 is bend along its length at a 90 degree angle relative to the leg plane 220. The edges of each panel-engagement feature 116 may be of any suitable shape, but may be provided with at least one sharp edge to better grasp the panel 104 upon assembly.

The legs 212 can use one or more retaining tabs 210 to engage the tower 108. Once the tower 108 is interested into the channel 214, the one or more retaining tabs 210 engage the tower 108 via, for example, an interference fit. Further, inserting the tower 108 into the channel 214 biases the legs 212 outwardly (e.g., away from one another) and against the panel 104 (via the opening 110). This outward bias pushes the panel-engagement feature 116 into the material of the panel 104, while also increasing the contact pressure between the tower 108 and the one or more retaining tabs 210.

In one example, the one or more retaining tabs 210 are coupled to the legs 212 and extend downwardly and inwardly into the channel 214. For example, from an upper surface 208a of an aperture 208. As illustrated, the one or more retaining tabs 210 are oriented inward and toward the leading end 112. Additionally or alternatively, one or more retaining tabs 210 are coupled to the head portion 204 at or adjacent the window 114 and inclined inward and toward the leading end 112. The one or more retaining tabs 210 coupled to the head portion 204 can be formed or defined when the window 114 is punched during manufacture of the blanks. In some examples, the aperture 208 may be omitted. For example, one or both of the pair of legs 212 may be stamped to define one more retaining tabs 210 without the aperture 208. The retaining tabs 210 on opposite sides of the channel 214 may be symmetrical with respect to one another.

While each of the legs 212 is illustrated with one retaining tab 210 and the head portion 204 includes six retaining tabs 210 (three on each side of the channel 214), one of skill in the art would understand that additional or fewer retaining tabs 210 can be used. For example, a leg 212 may be provided with multiple retaining tabs 210 or even no retaining tabs 210. In the latter example, rather than being sandwiched between two retaining tabs 210 as illustrated, the tower 108 may be secured against (e.g., biased toward) one leg 212 using a retaining tab 210 of the other leg 212. Similarly, depending on design needs, the retaining tabs 210 can be omitted from the head portion 204 if the tower 108 is otherwise adequately secured.

The retaining tabs 210 can be connected to its respective leg 212 at the upper surface 208a of the aperture 208 (e.g., the surface of the apertures 208 proximate the retaining head portion 204). In other examples, the one or more retaining tabs 210 may be provided on only one side of the channel 214. The retaining tab 210 may be formed, for example, during a stamping process and bent inward toward the channel 214. Therefore, the retaining tab 210 may be integral with its respective leg 212. The tips of each retaining tab 210 may be of any suitable shape, but may be provided with at least one sharp edge to better grasp the tower 108 upon assembly.

The retainer 106a is designed to be installed into a panel 104 with an opening 110, which may be rectangular or any other suitable shape. The tower 108 of the component 102 is then pressed into the channel 214 formed by the body portion 202 such that the retaining tab(s) 210 interact with the tower 108 to resist the tower 108 (and therefore the component 102) from being removed from the channel 214. As noted above, installing the retainer 106a first within the panel 104 first and then within the component 102 allows for both a smaller-sized retainer 106a and opening 110. The tower 108 reinforces the retainer 106a and provides resistance to removal of the retainer 106a from the panel 104. Further, the tower 108 becomes integral to the retaining system 100 by preventing the retainer 106a from being able to extract from the panel 104.

Once the tower 108 is fully seated within the retainer 106a, the retaining tabs 210 and the panel-engagement features 116 act to prevent the component 102 and panel 104 from being easily separated. For example, when a withdrawal force (a pullout force) is applied to the component 102, the interaction between the retaining tabs 210 and the panel-engagement features 116 and the panel-engagement features 116 will generate opposing forces. In some examples, the pair of legs 212 of the body portion 202 of the retainer 106a may be biased outwardly to further engage a feature (e.g., a retaining ledge) of the panel 104 so as to securely retain the retainer 106a within the opening 110 formed in the panel 104.

The flexible nature of the retaining tabs 210 and the legs 212 permit a relatively low insertion force required to insert the retainer into the opening 110 and, then, the tower 108 into the window 114 of the retainer 106a. In some example, the insertion force may be about two pounds. In the illustrated example, the retainer 106a define one or more sets of retaining tabs 210 to engage the tower 108. However, it is to be understood that the retainer 106a may comprise any number of retaining tabs 210 and/or panel-engagement features 116.

The panel-engagement features 116 and/or retaining tabs 210 of the retainer 106a may engage a planar surface of the tower 108 as illustrated or, in some examples, one or more features formed in or on the surface of the tower 108. For example, the tower 108 may comprise one or more bumps, recesses, apertures, or ledges to increase friction between the tower 108 and the retaining tabs 210 and/or the panel-engagement features 116.

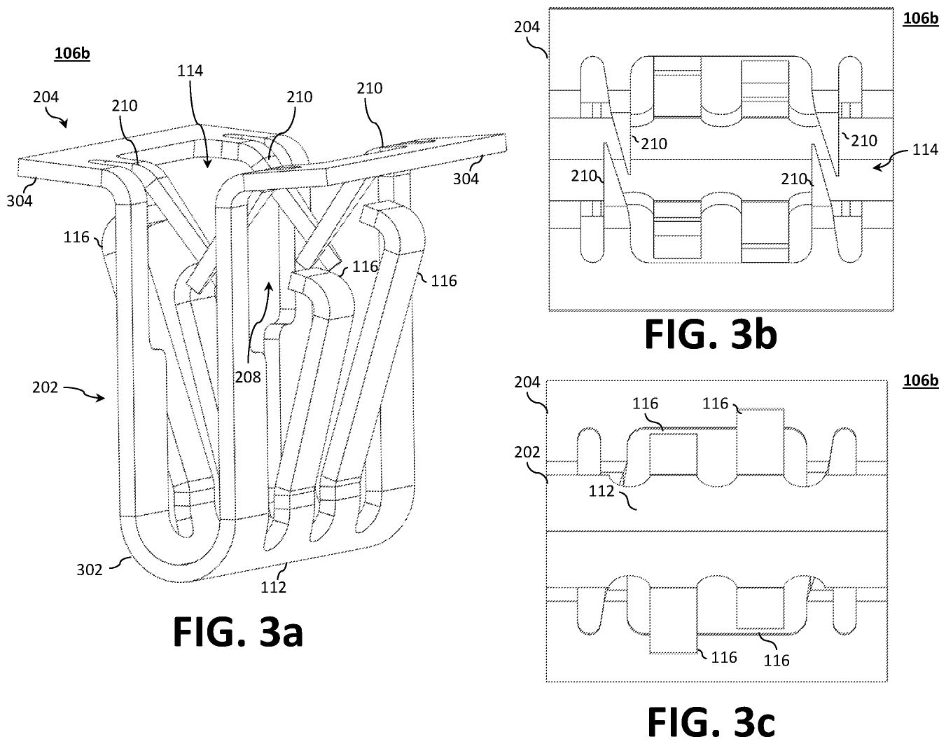

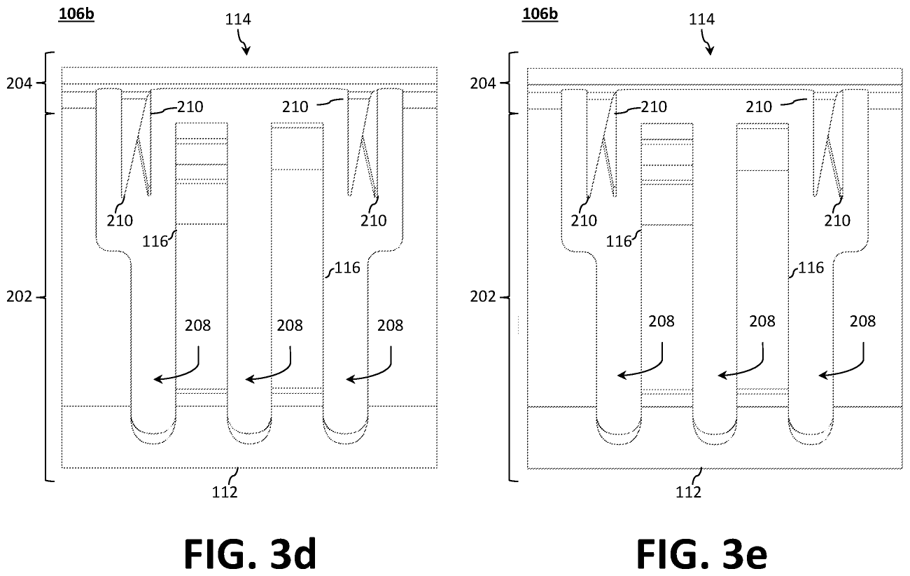

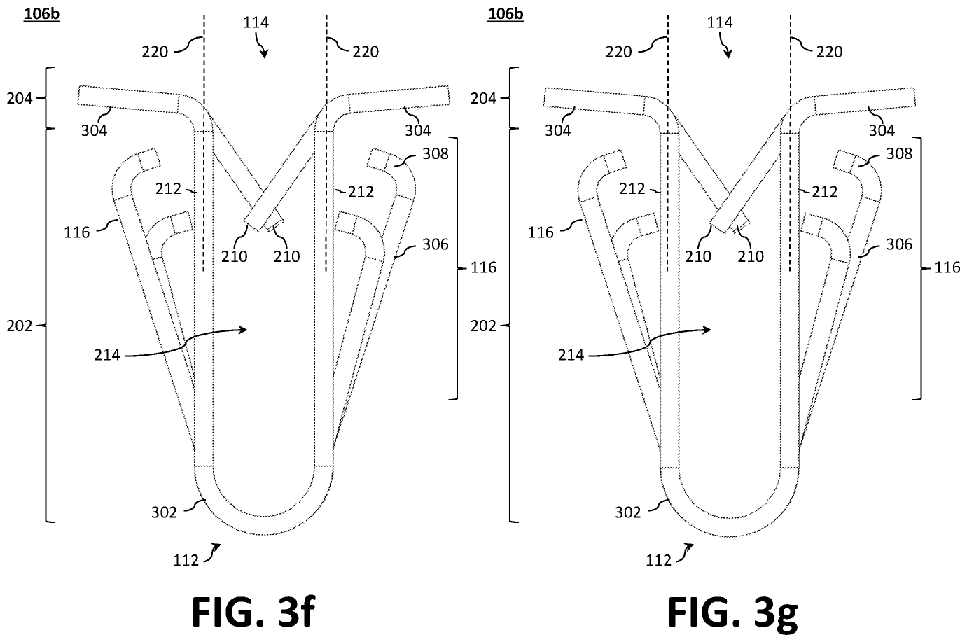

FIG. 3a illustrates a perspective view of a retainer 106b in accordance with another aspect of this disclosure. FIG. 3b illustrates a top plan view of the retainer 106b, while FIG. 3c illustrates a bottom plan view of the retainer 106b. FIGS. 3d through 3g illustrate first, second, third, and fourth side elevation views of the retainer 106b. The retainer 106b is similar to the retainer 106a described in connection with FIGS. 2a through 2g and, for brevity, corresponding features will not be reiterated, but instead, with an emphasis on the differences and/or additional features. For example, like the retainer 106a described in connection with FIGS. 2a through 2g, the retainer 106b is a stamped-metal retainer that is configured to form a blind connection with panels 104 of various thicknesses, but in this example, the panel-engagement features 116 are provided using a spring-tab structure instead of a saw-tooth structure. Further, as will be discussed, the retaining head portion 204 and the leading end 112 of the retainer 106b employ different designs.

The retainer 106b generally comprises a body portion 202 and a retaining head portion 204. In this example, the body portion 202 is formed from a pair of opposing legs 212 that are resiliently connected at their bottom ends via a connecting portion 302 (e.g., a portion that defines the bend, joint, etc.) to form, in one example, a generally U-shaped body having a channel 214 (e.g., a U-shaped channel) therebetween. The pair of opposing legs 212 are resiliently connected in that the pair of opposing legs 212 default to a predetermined shape.

Each of the legs 212 is formed with one or more flanges 304 extending outwardly to form the retaining head portion 204 of the retainer 106b. Each flange 304 may be shaped as a spring and configured to absorb movement between the component 102 and panel 104 once assembled, while also increasing manufacturing tolerances. In some examples, the set of flanges 304 may be canted to define the spring. Absorbing movement offers advantages, such as noise-reduction to limit BSR (e.g., fewer squeaks, creaks, etc.) and mitigating risk of the retaining system 100 becoming loose.

In some aspects, akin to the retainer 106a, each of the legs 212 is formed with one or more apertures 208 therethrough. For example, the panel-engagement features 116, retaining tabs 210, etc. can be stamped and bent outward (toward and/or away from the channel 214) using the material punched from the aperture 208. While each of the legs 212 is illustrated with two retaining tabs 210 adjacent the retaining head portion 204, one of skill in the art would understand that greater of fewer retaining tabs 210 may be employed.

In the illustrated example, the retainer 106b includes four panel-engagement features 116, although additional or fewer panel-engagement features 116 may be provided based on, for example, the size and/or dimensions of the body portion 202. In this example, the panel-engagement features 116 are embodied as a spring-tab structure having a spring tab 306 and a foot 308 at a distal end thereof, the toe (e.g., distal end) of which generally faces inwardly toward the channel 214. As illustrated, the spring tabs 306 on given side of the channel 214 are of different lengths to engage a wider range of panels 104 (e.g., panels of various thicknesses). The panel-engagement features 116 are further configured to engage the tower 108 via the feet 308 of the spring tabs 306 to provide outward tension on the panel-engagement features 116 to ensure positive engagement of the panel-engagement features 116 with the panel 104. Further, the spring tabs 306 of different lengths allow for the panel-engagement features 116 to engage the tower 108 at multiple points along the length of the tower 108, instead of only the retaining tabs 210.

The panel-engagement features 116 may be formed, for example, during a stamping process and bent at the pivot point outward away from the channel 214. Therefore, the panel-engagement feature 116 may be integral with its respective leg 212. The edges of each panel-engagement feature 116 may be of any suitable shape.

The aforementioned panel-engagement features 116 are not restricted to the described retainer designs, but rather, can be used with virtually any stamped metal retainer and the quantity of panel-engagement features 116 can be adjusted (e.g., increased or decreased) to achieve a desired pullout strength.

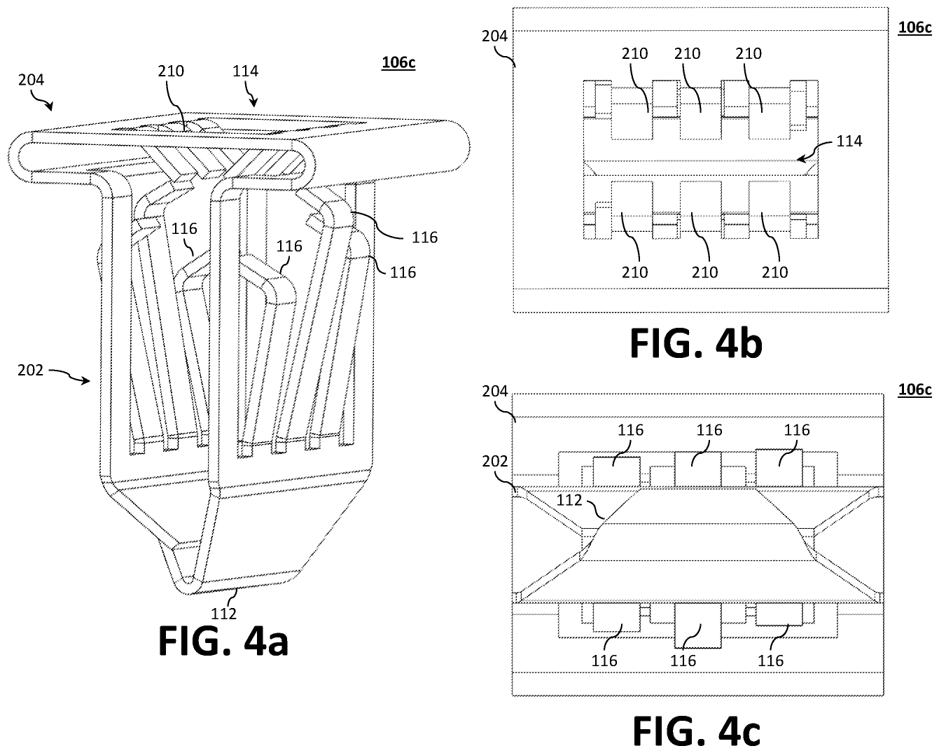

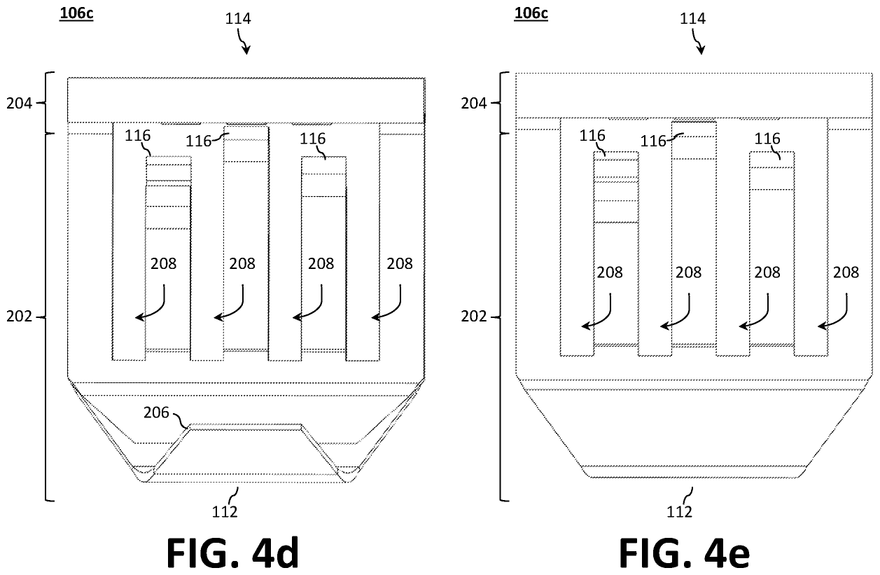

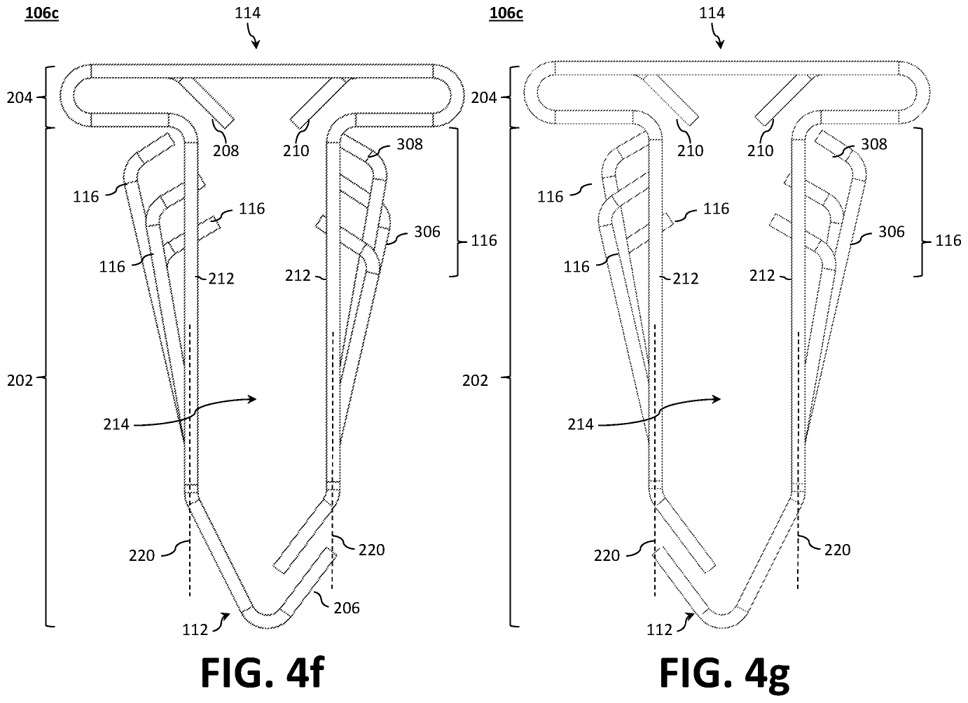

FIG. 4a illustrates a perspective view of a retainer 106c in accordance with yet another aspect of this disclosure. FIG. 4b illustrates a top plan view of the retainer 106c, while FIG. 4c illustrates a bottom plan view of the retainer 106c. FIGS. 4d through 4g illustrate first, second, third, and fourth side elevation views of the retainer 106c. The retainer 106c is similar to the retainer 106a described in connection with FIGS. 2a through 2g and, for brevity, corresponding features will not be reiterated, but instead, with an emphasis on the differences and/or additional features. For example, like the retainer 106a described in connection with FIGS. 2a through 2g, the retainer 106c is a stamped-metal retainer that is configured to form a blind connection with panels 104 of various thicknesses, but in this example, the panel-engagement features 116 are provided using a spring-tab structure instead of a saw-tooth structure.

In the illustrated example, the retainer 106c includes six panel-engagement features 116, although additional or fewer panel-engagement features 116 may be provided based on, for example, the size and/or dimensions of the body portion 202. In this example, the panel-engagement features 116 are embodied as a spring-tab structure having a spring tab 306 resiliently connected to the leg 212 at a first end and a foot 308 coupled to a second end thereof (i.e., a distal end). In some examples, the foot 308 is oriented (e.g., faces) inwardly toward the channel 214 to engage the tower 108 when assembled.

As illustrated, and described in connection with the retainer 106b of FIGS. 3a through 3g, the spring tabs 306 on given side of the channel 214 are of different lengths to engage a wider range of panels 104 (e.g., panels of various thicknesses). The panel-engagement features 116 are further configured to engage the tower 108 via the feet 308 of the spring tabs 306 to provide outward tension on the panel-engagement features 116 to ensure positive engagement of the panel-engagement features 116 with the panel 104. Further, the spring tabs 306 of different lengths allows for the panel-engagement features 116 to engage the tower 108 at multiple points along the length of the tower 108, instead of only the retaining tabs 210.

The panel-engagement features 116 may be formed, for example, during a stamping process and bent at the pivot point outward away from the channel 214. Therefore, the panel-engagement feature 116 may be integral with its respective leg 212. The edges of each panel-engagement feature 116 may be of any suitable shape.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A retainer to couple a component with panels of different thicknesses, the retainer comprising:
a retaining head portion;
a body portion extending from the retaining head portion, the body portion having a pair of legs spaced apart and flexibly connected to one another to define a channel, wherein the channel is configured to receive a tower associated with the component; and
at least one panel-engagement feature coupled to one of the pair of legs and configured to engage an opening of a panel having a thickness ranging from a first thickness (T₁) to a second thickness (T₂) that is greater than the first thickness (T₁).

2. The retainer of claim 1, wherein the at least one panel-engagement feature is a saw-tooth structure.

3. The retainer of claim 2, wherein the saw-tooth structure comprises a fin and a plurality of steps.

4. The retainer of claim 3, wherein each of the plurality of steps is offset relative to the one of the pair of legs.

5. The retainer of claim 1, wherein the at least one panel-engagement feature includes a plurality of spring-tab structures.

6. The retainer of claim 5, wherein each of the plurality of spring-tab structures comprises a spring tab resiliently connected at a first end to one of the pair of legs and a foot coupled to a second end of the spring tab.

7. The retainer of claim 6, wherein the foot is oriented toward the channel.

8. The retainer of claim 5, wherein each of the plurality of spring-tab structures are of a different length.

9. The retainer of claim 1, further comprising a retaining tab extending inwardly from one of the pair of legs to the channel.

10. The retainer of claim 1, further comprising a pair of flanges, wherein each of the pair of flanges is connected to and extends outwardly from the body portion.

11. The retainer of claim 10, wherein each of the pair of flanges is shaped as a spring to absorb movement between the component and the panel.

12. The retainer of claim 1, wherein the at least one panel-engagement feature is arranged to both engage and retain the tower within the channel and engage and retain the retainer within the opening.

13. The retainer of claim 1, wherein the pair of legs are parallel to one another.

14. The retainer of claim 1, wherein the retainer is a stamped-metal retainer.

15. A stamped-metal retainer to couple a component with panels of different thicknesses, the retainer comprising:
a body portion having a pair of legs spaced apart and flexibly connected to one another to define a channel, wherein the channel is configured to receive a tower associated with the component; and
at least one panel-engagement feature coupled to one of the pair of legs and configured to engage an opening of a panel having a thickness ranging from a first thickness (T₁) to a second thickness (T₂) that is greater than the first thickness (T₁), wherein the at least one panel-engagement feature is a saw-tooth structure.

16. The stamped-metal retainer of claim 15, wherein the saw-tooth structure comprises a fin and a plurality of steps.

17. The stamped-metal retainer of claim 15, wherein the at least one panel-engagement feature is arranged to both engage and retain the tower within the channel and engage and retain the retainer within the opening.

18. A stamped-metal retainer to couple a component with panels of different thicknesses, the retainer comprising:
a body portion having a pair of legs spaced apart and flexibly connected to one another to define a channel, wherein the channel is configured to receive a tower associated with the component; and
at least one panel-engagement feature coupled to one of the pair of legs and configured to engage an opening of a panel having a thickness ranging from a first thickness (T₁) to a second thickness (T₂) that is greater than the first thickness (T₁),
wherein the at least one panel-engagement feature is arranged to both engage and retain the tower within the channel and engage and retain the retainer within the opening.

19. The stamped-metal retainer of claim 18, wherein the at least one panel-engagement feature includes a plurality of spring-tab structures, wherein each of the plurality of spring-tab structures comprises a spring tab resiliently connected at a first end to the leg and a foot coupled to a second end of the spring tab.

20. The stamped-metal retainer of claim 19, wherein each of the plurality of spring-tab structures are of a different length.
